(19) United States
(12) Patent Application Publication
(10) Pub. No.: US 2011/0119715 A1
(43) Pub. Date: May 19, 2011

(54) MOBILE DEVICE AND METHOD FOR GENERATING A CONTROL SIGNAL

(75) Inventors: Woo-Yong CHANG, Yongin-si (KR); Seung-dong Yu, Osan-si (KR); Se-jun Park, Yongin-si (KR); Min-jeong Moon, Seongnam-si (KR)

(73) Assignee: Samsung Electronics Co., Ltd., Suwon-si (KR)

(21) Appl. No.: 12/946,490

(22) Filed: Nov. 15, 2010

(30) Foreign Application Priority Data
Nov. 13, 2009 (KR) 10-2009-0109560

(51) Int. Cl. H04N 5/445

(52) U.S. Cl. 725/53; 704/275

(57) ABSTRACT

A mobile device and method are provided. The mobile device includes an input unit that receives a user voice command, a keyword extracting unit that extracts at least one keyword from the user voice command, a search unit that searches Electronic Program Guide (EPG) data for broadcast information related to the at least one keyword, and a generating unit that generates a broadcast control signal corresponding to the broadcast information related to the at least one keyword.

### PRIORITY

This application claims priority under 35 U.S.C. §119(a) to Korean Patent Application No. 10-2009-0109560, filed on Nov. 13, 2009, in the Korean Intellectual Property Office, the disclosure of which is incorporated herein by reference.

### BACKGROUND OF THE INVENTION

1. Field of the Invention

The present invention relates generally to a mobile device, and more particularly, to a mobile device capable of controlling a broadcast channel and a method for generating a control signal thereof.

2. Description of the Related Art

Remote controls are commonly provided for controlling generally stationary electronic home appliances, such as TeleVisions (TVs) and air conditioners, from a distance. However, even with the added convenience of remote controls, a user is still required to manually perform a task. For example, if a user watching TV would like to change the channel, the user must pick up the remote and manually enter a command into the remote control, in order to change the channel.

Accordingly, a need exists for a remote control that operates in response to a user voice command, e.g., to select a desired broadcast channel. This type of remote control would be especially beneficial to users with limited ability to move.

Further, a need exists for a remote control that allows a user to search broadcast channels, even when the user does not have information about service providers or channel numbers of desired programs.

### SUMMARY OF THE INVENTION

The present invention has been made to address at least the above problems and/or disadvantages and to provide at least the advantages described below.

Accordingly, an aspect of the present invention is to provide a mobile device that changes a broadcast channel using voice recognition technology, and a method for generating a control signal to change the broadcast channel.

In accordance with an aspect of the present invention, a method for generating a control signal of a mobile device communicating with at least one external device is provided. The method includes storing an Electronic Program Guide (EPG), receiving a user voice command, extracting at least one keyword from the user voice command, searching the EPG for broadcast information related to the at least one extracted keyword, and generating a broadcast control signal corresponding to the broadcast information related to the at least one extracted keyword.

In accordance with another aspect of the present invention, a mobile device that communicates with at least one external device is provided. The mobile device includes a storage unit that stores an Electronic Program Guide (EPG), an input unit that receives a user voice command, a keyword extracting unit that extracts at least one keyword from the user voice command, a search unit that searches the EPG for broadcast information related to the at least one extracted keyword, and a generating unit that generates a broadcast control signal corresponding to the broadcast information related to the at least one extracted keyword.

### BRIEF DESCRIPTION OF THE DRAWINGS

The above and other aspects, features, and advantages of the present invention will be more apparent from the following detailed description when taken in conjunction with the accompanying drawings, in which:

FIG. 1 illustrates a control system using a mobile device according to an embodiment of the present invention;

FIG. 2A illustrates a principle of operating a control system using a mobile device according to an embodiment of the present invention;

FIG. 2B illustrates an example of an EPG;

FIG. 3 illustrates a principle of operating a control system using a mobile device according to an embodiment of the present invention;

FIG. 4 illustrates an example of a screen displayed on a display unit according to an embodiment of the present invention;

FIG. 5 is a flowchart illustrating a method for generating a control signal of a mobile device according to an embodiment of the present invention;

FIG. 6 is a flowchart illustrating a method for generating a control signal of a mobile device according to another embodiment of the present invention;

FIG. 7 illustrates a principle of operating a control system using a mobile device according to an embodiment of the present invention; and

FIG. 8 illustrates a principle of operating a control system using a mobile device according to another embodiment of the present invention.

### DETAILED DESCRIPTION OF EMBODIMENTS OF THE PRESENT INVENTION

Various embodiments of the present invention are described in detail with reference to the accompanying drawings. In the description, the same or similar reference numerals may be used for the same or similar elements when they are illustrated in different drawings. Additionally, detailed descriptions of constructions or processes that are commonly known in the art may be omitted to avoid obscuring the subject matter of the present invention.

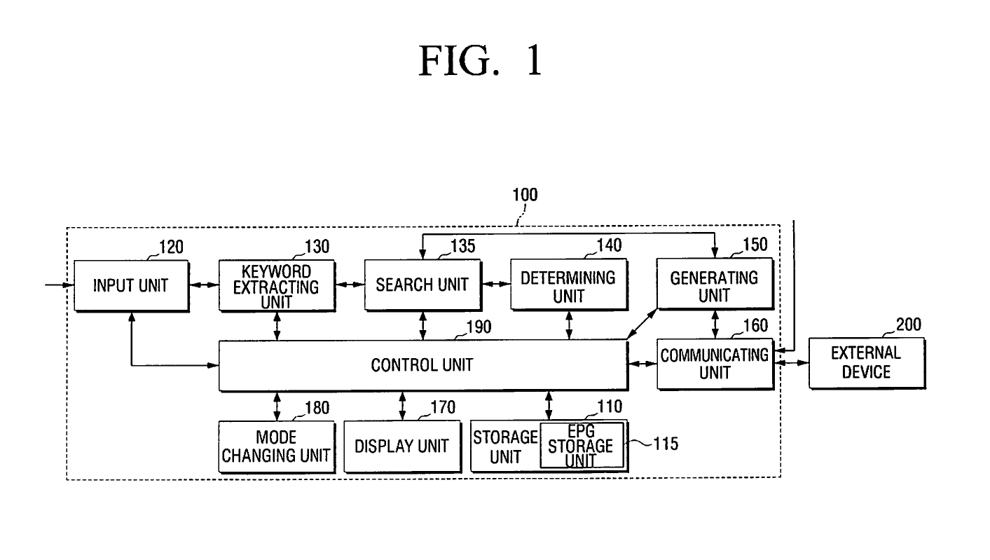

FIG. 1 illustrates a control system using a mobile device according to an embodiment of the present invention.

Referring to FIG. 1, the control system includes a mobile device 100 and an external device 200. The mobile device 100 communicates with the external device 200 and generates a control signal to control the external device 200. For example, the mobile device 100 may be a Personal Digital Assistant (PDA), an MP3 player, a Portable Media Player (PMP), a cellular phone, a smart phone, a tablet Personal Computer (PC), etc, and the external device 200 may be a stationary home device, such as a TV. Although FIG. 1 illustrates the mobile device 100 communicating with one external device 200, the mobile device 100 may communicate with a plurality of external devices 200.

The mobile device 100 includes a storage unit 110, i.e., a memory, an input unit 120, a keyword extracting unit 130, a search unit 135, a determining unit 140, a generating unit 150, a communicating unit 160, a display unit 170, a mode changing unit 180, and a control unit 190.

The storage unit 110 stores Electronic Program Guide (EPG) data therein. The EPG data includes various schedule or other related information about broadcast programs, including program titles, broadcaster names, channel numbers, summaries of programs, broadcast program reservation numbers, cast information of broadcast programs, etc. The storage unit 110 may periodically receive the EPG data for ground wave broadcasts, cable broadcasts, or satellite broadcasts transmitted from broadcasting stations via the communicating unit 160, or receive previously stored EPG data from the external device 200, and then store the received EPG data. Additionally, the received EPG data may be updated at the storage unit 110. The storage unit 110 also stores EPG data regarding a broadcast program to be played back on the external device 200 or the mobile device 100.

As illustrated in FIG. 1, the storage unit 110 may include a designated EPG storage unit 115 (or area) for separately storing the EPG data, such that it is easier to search the EPG data. However, a designated EPG storage unit 115 (or area) is not necessary.

The input unit 120 receives a user voice command, e.g., to change a channel. The input unit 120 may be a microphone.

The keyword extracting unit 130 extracts at least one keyword from the user voice command. For example, the keyword extracting unit 130 analyzes frequencies of an electrical signal produced by the input unit 120, to extract the keyword from the user voice command.

More specifically, when a user speaks the user voice command “Change the channel to CNN” into the input unit 120, the input unit 120 converts the user voice command into an electric signal. The keyword extracting unit 130 analyzes frequencies of the electrical signal and extracts “CNN”, “channel”, and “change” as keywords. Searching using the extracted keywords may be performed in a number of ways, e.g., searching each of keywords individually or in different combinations.

Accordingly, the input unit 120 and the keyword extracting unit 130 provide natural language processing of the user voice command to change channels.

The search unit 135 searches for broadcast information related to an extracted keyword from the stored EPG data. The broadcast information may include program titles, broadcast provider names, channel numbers, particulars of broadcasts, and/or broadcast-related information. Broadcast-related information, as used herein, may include broadcast information corresponding to an extracted keyword, and broadcast information similar to the extracted keyword.

If the broadcast information related to an extracted keyword is a broadcast program title, the determining unit 140 may determine if the broadcast program is currently airing.

Additionally, the determining unit 140 determines if an extracted keyword is included in the EPG data according to the search results of the search unit 135. The determining unit 140 determines if a keyword similar to the extracted keyword is to be searched from the EPG. Additionally, the determining unit 140 may determines similar words for an extracted keyword.

The generating unit 150 generates a broadcast control signal corresponding to the searched broadcast information, according to the result of searching described above.

For example, the broadcast control signal may include a control signal to change a broadcast channel, a control signal to play back previously stored broadcast program, and a control signal to record a program to air in the future.

If the broadcast control signal is for changing a broadcast channel, the generating unit 150 generates a control signal to change the broadcast channel. More specifically, when the determining unit 140 determines that the broadcast program is currently airing, the generating unit 150 generates a control signal to change the current broadcast channel to a broadcast channel that is providing the broadcast program.

Additionally, the generating unit 150 may generate a control signal to play back previously stored broadcast program on the external device 200. For example, if it is determined that the broadcast program has previously been previously recorded and is not currently airing, the generating unit 150 generates a control signal to play back the previously stored broadcast program on the external device 200.

Additionally, if the program is not currently airing, but will be aired at a later time, the generating unit 150 generates a control signal to record to switch to the broadcast program at the later time.

The communicating unit 160 communicates with the external device 200. For example, the communicating unit 160 transmits, to the external device 200, a control signal to change channels of the external device 200, or a control signal to play back the previously stored broadcast program on the external device 200. Additionally, the communicating unit 160 may receive EPG data transmitted from the broadcasting station or the external device 200. For example, if the mobile device 100 is registered in a webpage of a broadcasting station, or changed to an EPG registration mode, the mobile device 100 may receive EPG data via the communicating unit 160. Alternatively, if the mobile device 100 is connected to the external device 200 in which EPG data is stored in advance, the mobile device 100 may receive the previously-stored EPG data from the external device 200, via the communicating unit 160.

The communicating unit 160 may periodically receive channel information about a broadcast program currently airing on the external device 200. For example, if the external device 200 periodically broadcasts channel information of the currently-airing broadcast program, the communicating unit 160 periodically receives the channel information of the currently-airing program as broadcast by the external device 200.

In another example, the mobile device 100 may receive the channel information of a currently-airing broadcast program, if the mobile device 100 is paired with the external device 200. In this example, a pairing button, attached to a predetermined area of the mobile device 100, may be used.

According to yet another example, as a user voice command is received at the input unit 120 of the mobile device 100, the communicating unit 160 may transmit a signal to request channel information of the currently-airing broadcast program to the external device 200, and then receive a response signal from the external device 200.

Accordingly, the communicating unit 160 may be implemented as any one of the various available types of wireless communication interfaces, e.g., Bluetooth®, WiFi®, etc.

If the determining unit 140 determines that an extracted keyword is not included in the EPG data, the display unit 170 may display a message, indicating that the broadcast is not provided by the mobile device 100 or the external device 200. The message may include text, an icon, or a video, and is not limited to these specified examples.

Further, when it is determined that the broadcast program is not currently airing, the display unit 170 may display a message to indicating that the broadcast program is not currently airing.

Additionally, the display unit 170 may display a date and time at which the broadcast program has aired, or is scheduled to air. In this example, the display unit 170 may display a message to inquiring whether or not to play back a previously-stored broadcast program, or display a message to reserve (or record) the broadcast program scheduled to air.

If the determining unit 140 determines that a keyword similar to the extracted keyword is to be searched from the EPG data, the display unit 170 may display the similar keyword.

The display unit 170 may display a message, date, or time as a popup window, and receive additional user commands as a touch screen.

The mode changing unit 180 changes the operating mode of the mobile device 100, e.g., from a telephone mode to a remote control mode for changing a broadcast channel of the external device 200.

The control unit 190 controls the overall operations of the mobile device 100. Specifically, the control unit 190 controls the storage unit 110, the input unit 120, the keyword extracting unit 130, the search unit 135, the determining unit 140, the generating unit 150, the communicating unit 160, the display unit 170, and the mode changing unit 180. Accordingly, the control unit 190 can control the mobile device 100 to change a channel currently being shown on the mobile device 100 or on the external device 200.

In accordance with an embodiment of the present invention, the mobile device 100 is able to change the broadcast channels of the mobile device 100 and the external device 200 in accordance with a received user voice command.

The external device 200 may include a communicating unit (not illustrated) to communicate with the mobile device 100, e.g., to receive a control signal from the mobile device 100, a control unit (not illustrated) to control the overall operation of the external device, a storage unit (not illustrated) to store a broadcast program or EPG data, and a display unit (not illustrated) to display the broadcast.

Although the control system illustrated in FIG. 1 includes the mobile device 100 communicating directly with the external device 200, in accordance with another embodiment of the present invention, a settop box (not illustrated) may be used to connect the mobile device 100 and the external device 200 to each other. The settop box (not illustrated) may perform almost all the functions of the external device 200, as explained above.

The mobile device 100 analyzes a voice command spoken by a user, such as “change”, “switch”, “turn on”, “turn off”, “record”, “raise volume”, and “lower volume”, etc. Accordingly, the mobile device 100 executes a variety of functions of recognizing voice command spoken by a user as a voice recognition remote controller.

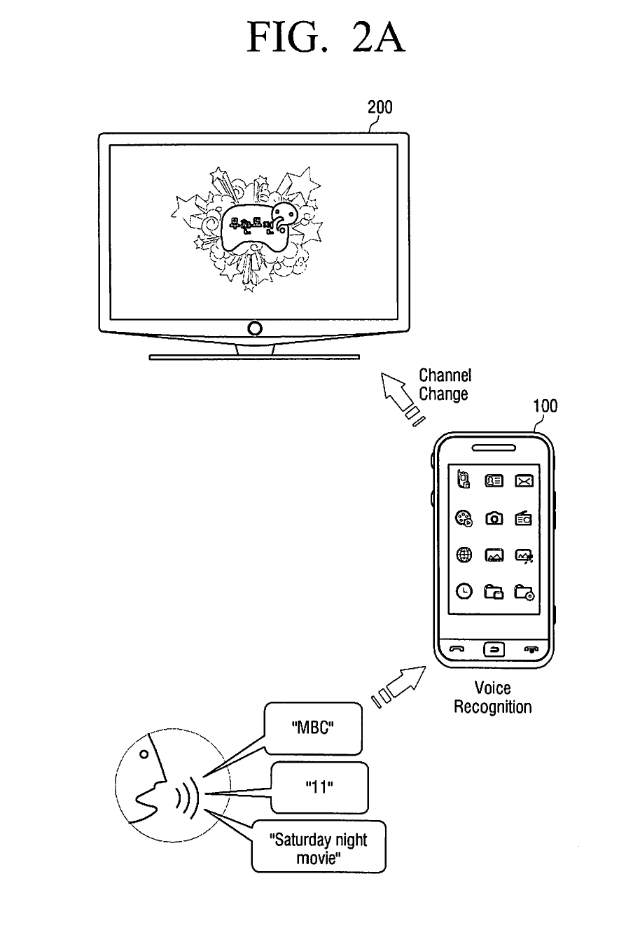

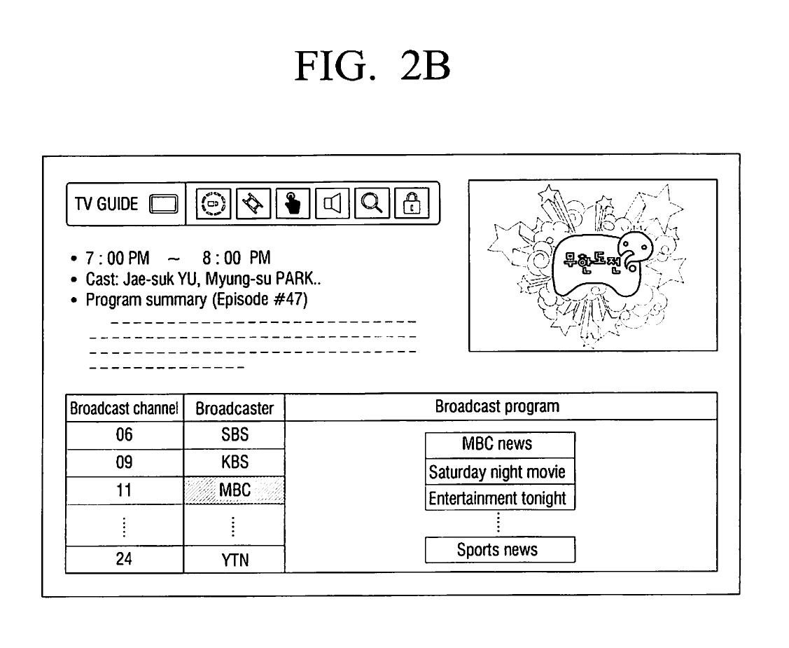

FIG. 2A illustrates an operation of a control system according to an embodiment of the present invention.

Referring to FIG. 2A, the control system includes the mobile device 100 and the external device 200. The mobile device 100 receives broadcast information from the input unit 120, e.g., a broadcast program title, a broadcaster name, channel information, and/or other particulars of a broadcast.

For example, when a user is currently watching channel 24, and speaks a user voice command of “MBC”, which is a broadcaster name, into the input unit 120, the keyword extracting unit 130 extracts “MBC” as a keyword from the user voice command. Although in this example, the user merely speaks a single word “MBC” as user voice command, the user voice command inputted to the input unit 120 may also be in sentence form, such as “Switch to MBC channel”. In this case, the keyword extracting unit 130 may extract at least one keyword including “MBC”, “channel”, “switch”, or the like.

The search unit 135 searches the extracted keyword “MBC” from the broadcast channel schedule information of EPG data previously stored at the storage unit 110. As described above, the EPG data is received from a broadcasting station or the external device 200, and may include broadcaster names such as “MBC” or “KBS”, a title of a program in a respective time slot, such as “Good morning Korea!” or “Saturday night movie”, or a channel number allotted with the broadcast program.

If “MBC”, i.e., the extracted keyword, is found in the EPG data, as a result of the search by the search unit 135, the generating unit 150 generates a control signal to change the currently-airing broadcast channel (e.g., channel 24) to the channel for MBC. For example, the generating unit 150 may determine from the EPG that MBC is broadcast on channel 11. Thereafter, the control signal indicating to change the channel to channel 11, is transmitted to the external device 200 from the communicating unit 160.

As described above, because the mobile device 100 receives a user voice command and changes a channel of the external device 200, user convenience is improved.

In one example, if a user voice command of “Minority report” is received and the search unit 135 does not find corresponding broadcast information regarding the movie Minority Report from the EPG data, the display unit 170 displays a message to notify that the requested broadcast is not provided by the mobile device 100 or the external device 200.

In another embodiment of the present invention, if a user voice command of “11”, is received at the input unit 120, the mobile device 100 operates in the same manner as in the case of receiving the user voice indicating broadcaster name (e.g., MBC).

In accordance with another embodiment of the present invention, if a user voice command indicates a broadcast program title (e.g., Good morning Korea!), the determining unit 140 determines if the broadcast program is currently airing. If “Good morning Korea!” is airing, the generating unit 150 generates a control signal to change broadcast channel of the external device 200 from the currently-airing broadcast channel (e.g., 24) to the broadcast channel providing “Good morning Korea!”. However, if “Good morning Korea!” is not airing, the display unit 170 displays a message to indicate that “Good morning Korea!” is not currently airing. Additionally, the display unit 170 may display a date and time at which “Good morning Korea!” previously aired, or is scheduled to air.

Additionally, if it is determined that “Good morning Korea!” has already been broadcast and recorded, the generating unit 150 may generate a control signal to play back “Good morning Korea!”. For example, the external device 200 may receive and store the previously-aired programs in advance, through communication with a web server (not illustrated).

Additionally, if “Good morning Korea!” has not aired yet, the generating unit 150 may generate a control signal to reserve “Good morning Korea!”. For example, the channel may automatically switch to “Good morning Korea!”, at the proper time, or the control signal may command the external device 200 to record “Good morning Korea!” in the future.

In accordance with another embodiment of the present invention, if a user voice command indicates the name of a person appearing in the program (e.g., Elizabeth Taylor), the search unit 135 searches the EPG data from programming associated with Elizabeth Taylor. After that, the generating unit 150 generates a control signal to change a channel to correspond to broadcast information located during the search.

FIG. 2B illustrates an example of an EPG.

Referring to FIG. 2B, the EPG includes a variety of information regarding a broadcast. For example, the EPG illustrated in FIG. 2B includes information about the broadcast channel, the broadcaster, and the broadcast program. Using the same example as presented above, if “MBC” is spoken into the mobile device 100, the broadcast programs provided by MBC, such as “MBC news”, “Saturday night movie”, or “Entertainment tonight” may be displayed.

If the broadcast program “Saturday night movie” is then selected, e.g., clicked using a touch screen input, particulars of the selected broadcast program, including airing time, stars appearing in the program, or summary of the program are displayed along with the program logo.

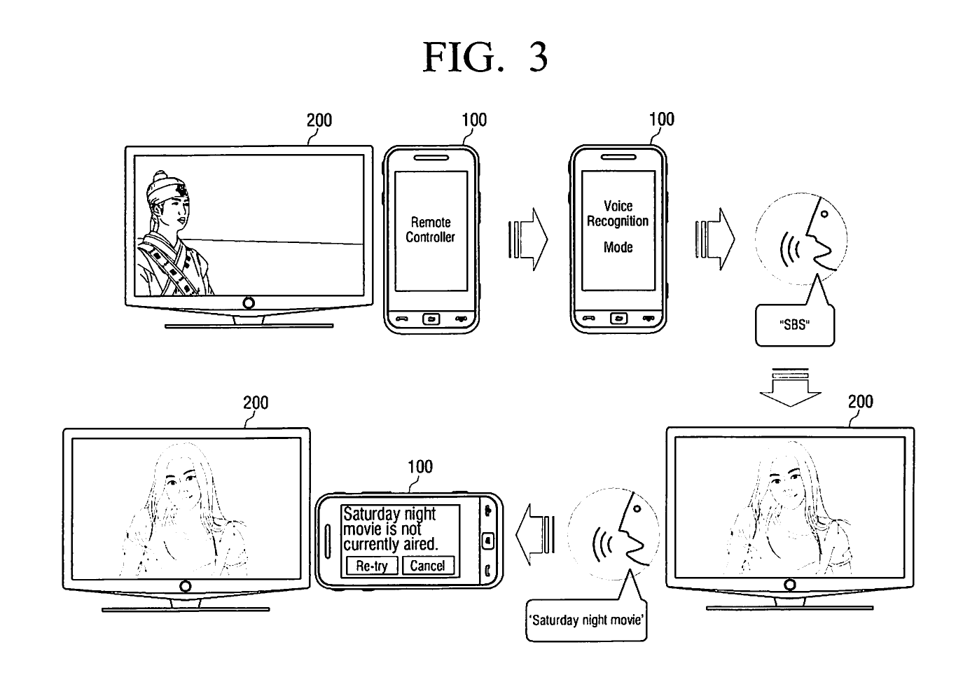

FIG. 3 illustrates operation of a control system according to an embodiment of the present invention.

Referring to FIG. 3, the external device 200 is currently airing a program provided by the MBC. Voice recognition is enabled in the mobile device 100 by changing the mode of the mobile device 100 from a remote control function to a voice recognition mode to change broadcast channels.

When a user voice command of broadcaster name “SBS” is spoken into the mobile device 100, the mobile device 100 generates a control signal to change from “MBC” to “SBS”, and transmits the generated control signal to the external device 200. Accordingly, the external device 200 changes the current channel (i.e., MBC) to SBS.

Thereafter, when a user voice command indicating “Saturday night movie” is spoken into the mobile device 100, the information regarding “Saturday night movie” is searched in the EPG data. However, because “Saturday night movie” is not currently airing, the mobile device 100 displays a message on the display unit 170 to indicate that “Saturday night movie” is not currently airing. However, if “Saturday night movie” is currently airing, the external device 200 may change to the channel airing “Saturday night movie”.

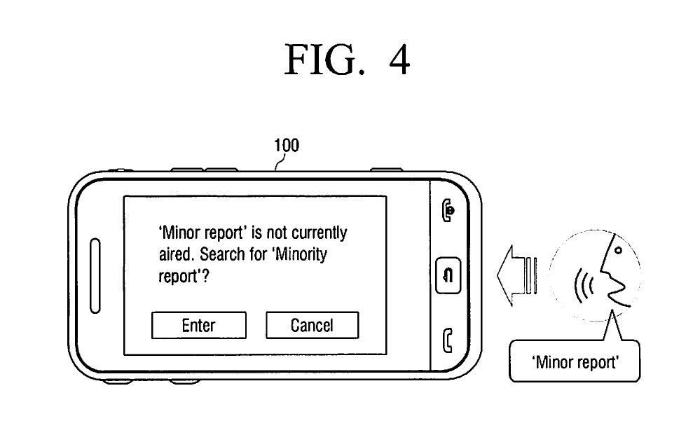

Referring to FIG. 4, it is assumed that the user erroneously speaks “Minor Report”, but intends to view “Minority Report”, and that the EPG data of the storage unit 110 includes broadcast information regarding “Minority Report”.

When “Minor Report” is received at the input unit 120, the search unit 135 searches broadcast information related to the keywords “Minor” and “Report” from the stored EPG data.

If broadcast information related to “Minor Report” is not found as a result of determination at the determining unit 140, but results are available for “Minority Report”, the control unit 190 controls the search unit 135 to search information related to “‘Minority Report”’, which is the most similar title to “Minor Report”.

If the search unit 135 searches “Minority Report” according to the control of the control unit 190, the display unit 170 may displays at least one keyword (i.e., Minority Report) that is similar to the extracted keyword “Minor Report”.

Although the keyword is “Minor report” in FIG. 4, according to alternative examples, the keyword may include one word, such as “minor” or “report”.

Furthermore, although “Minority” is recognized as being the most similar to “Minor” in the example illustrated in FIG. 4, based on the correspondence of the words, in other examples, the similarity of keywords may be determined based on the number of syllables, correspondence of first-occurring syllables, etc.

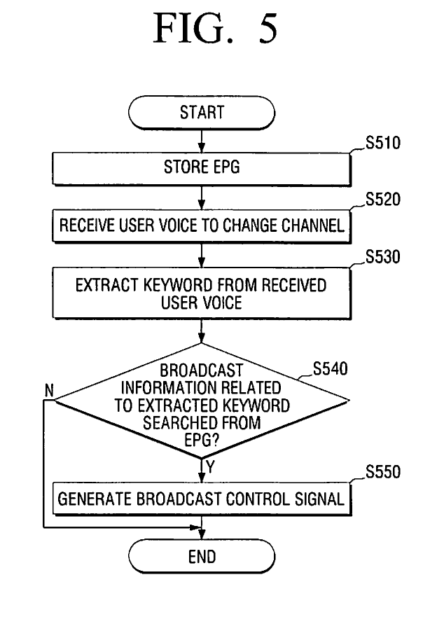

FIG. 5 is a flowchart illustrating a method for generating a control signal by a mobile device according to an embodiment of the present invention.

Referring to FIG. 5, the mobile device 100 stores EPG data in the storage unit 110 at step S510. A user voice command to change broadcast channel is received via the input unit 120 at step S520. In step S530, at least one keyword is extracted from the user voice command at the keyword extracting unit 130.

At step S540, the search unit 135 searches the EPG data for broadcast information including the at least one extracted keyword. When the broadcast information including the at least one extracted keyword is found in the EPG data, at step S550, the generating unit 150 generates a control signal to change to a broadcast channel corresponding to the broadcast information. When no broadcast information including the at least one extracted keyword is found in the EPG, no control signal is generated.

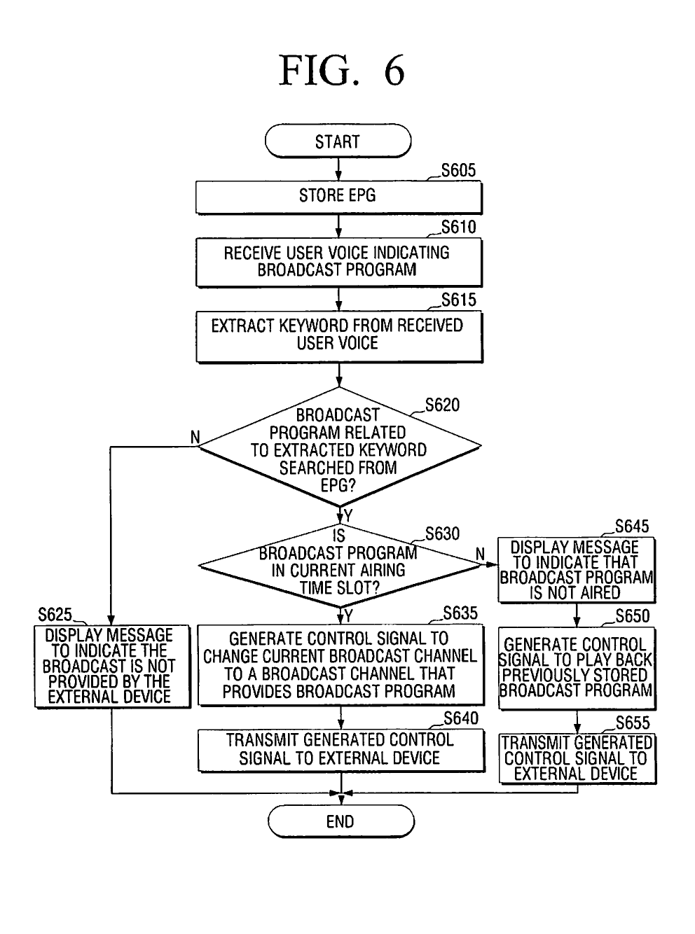

FIG. 6 is a flowchart illustrating a method for generating a control signal of a mobile device according to an embodiment of the present invention.

Referring to FIG. 6, the mobile device stores EPG data at the storage unit 110 at step S605, receives a user voice command indicating a broadcast program title to which the user wants to watch at step S610, and extracts at least one keyword from the user voice command at step S615. At 5620, the search unit 135 searches the EPG data for broadcast information related to the broadcast program title including the extracted keyword.

If it is determined, as a result of search, that the there is no broadcast information related to the broadcast program title including the extracted keyword, at step S625, a message is displayed, indicating that the requested program is not provided by the external device 200. However, if it is determined, as a result of search, that there is broadcast information related to the broadcast program title including the extracted keyword, at step S630, the determining unit 140 determines whether the broadcast program is currently airing.

If the determining unit 140 determines that the broadcast program is currently airing, at step S635, the generating unit 150 generates a control signal to indicate to change the current broadcast channel to a broadcast channel providing the requested broadcast program.

At step S640, the communicating unit 160 transmits the generated control signal to change channel to the external device.

However, if he determining unit 140 determines that the broadcast program is not currently airing, at step S645, a message indicating that the broadcast program is not currently provided, is displayed. At step S650, a control signal is generated to play back previously-stored broadcast program, and at step S655, the generated control signal is transmitted to the external device.

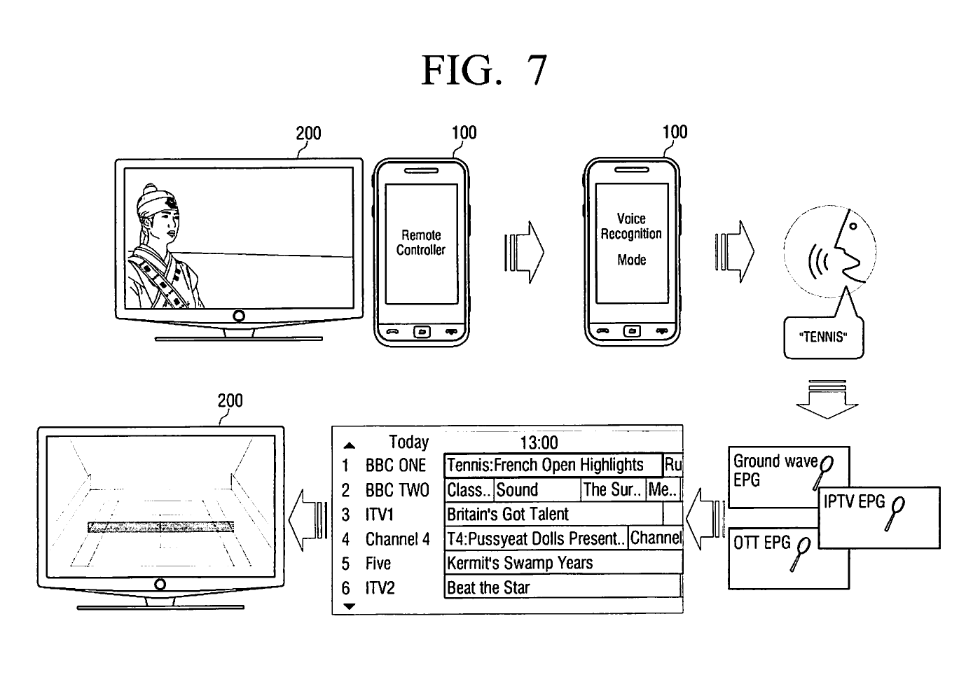

FIG. 7 illustrates an operation of a control system using a mobile device according to an embodiment of the present invention.

Referring to FIG. 7, the external device 200 is currently providing Internet Protocol TV (IPTV) broadcast program, and the mobile device 100 with a remote control function is changed to a voice recognition mode to change a broadcast channel. When a user voice command of “tennis” is spoken into the mobile device 100, the mobile device 100 confirms that the currently-airing broadcast program is IPTV broadcast program, and searches for broadcast programs related to “tennis” based on previously-stored IPTV EPG data.

If a broadcast program related to “tennis” is located within the IPTV EPG data, the mobile device 100 generates a control signal to change the channel to Channel 1, which is currently airing “Tennis; French Open Highlights”. Accordingly, the external device 200 or the mobile device 100 can change the current channel to Channel 1 using the generated control signal.

Although FIG. 7 illustrates an IPTV broadcast program, other examples are possible. Accordingly, if a ground wave broadcast program is currently provided to the mobile device 100, the mobile device 100 may similarly search related broadcast information from the ground wave EPG data. Additionally, if Over-The-Top (OTT) broadcast programming is currently provided to the mobile device 100, the mobile device 100 may search related broadcast information from the OTT EPG data.

Additionally, if a broadcast program related to “tennis” is located, the mobile device 100 may display the result of search on the display unit 170.

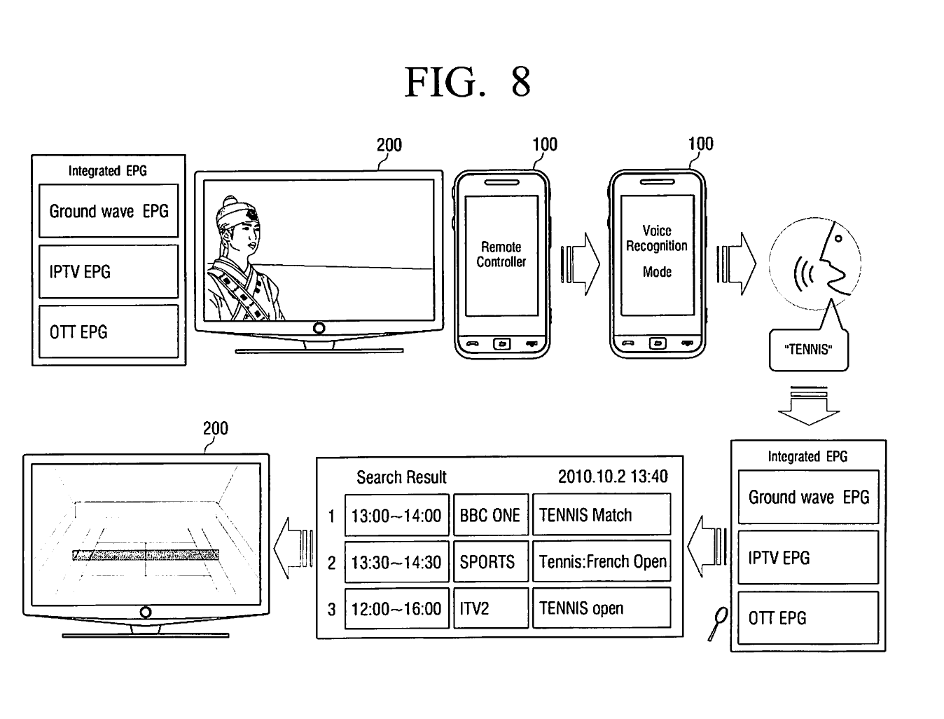

FIG. 8 illustrates an operation of a control system using a mobile device according to an embodiment of the present invention.

Referring to FIG. 8, when a user voice command of “tennis” is spoken into the mobile device 100, the mobile device 100 searches the EPG data for broadcast programs related to tennis. The integrated EPG may include, as illustrated in FIG. 8, ground wave EPG, IPTV EPG, and OTT EPG.

If broadcast program related to tennis is searched from the integrated EPG data, the mobile device 100 locates “TENNIS Match” from the ground wave EPG data, “Tennis: French Open Highlights” from the IPTV EPG data, and “Tennis open” from the OTT EPG data. The mobile device 100 displays the results of search from the integrated EPG on the display unit 170.

Thereafter, when one of the broadcast programs is selected on the display unit 170, the mobile device 100 generates a control signal to change to the broadcast channel corresponding to the selected program. Accordingly, the external device 200 or the mobile device 100 can change to a broadcast program channel selected by the user, using the generated control signal.

The IPTV EPG, ground wave EPG, OTT EPG and integrated EPG may be stored in the mobile device 100, and updated in real-time basis, or at predetermined time intervals. As an alternative example, the IPTV EPG, ground wave EPG, OTT EPG and the integrated EPG may be stored at the external device 200, and in this case, the mobile device 100 may search the IPTV EPG, ground wave EPG, OTT EPG and the integrated EPG stored at the external device 100, upon receiving a user voice command.

Furthermore, although ground wave EPG, IPTV EPG, or OTT EPG are explained above with reference to FIGS. 7 and 8, these are written only for illustrative purpose. Accordingly, the type of EPG is not limited to the examples specified above, but various other broadcast EPGs may be implemented.

While the present invention has been shown and described with reference to certain embodiments thereof, it will be understood by those skilled in the art that various changes in form and detail may be made therein without departing from the spirit and scope of the present invention, as defined by the appended claims.

What is claimed is:

1. A method for generating a control signal of a mobile device that communicates with an external device, the method comprising:
receiving a user voice command;
extracting at least one keyword from the user voice command;
searching Electronic Program Guide (EPG) data for broadcast information related to the at least one keyword; and
generating a broadcast control signal corresponding to the broadcast information related to the at least one keyword.

2. The method of claim 1, further comprising transmitting the broadcast control signal to the external device.

3. The method of claim 1, further comprising changing a current broadcast channel being displayed in mobile device to a broadcast channel corresponding to the broadcast control signal.

4. The method of claim 1, further comprising displaying a message indicating that there are no broadcasts provided by the external device or the mobile device corresponding to the user voice command, when no broadcast information related to the at least one keyword is found in searching the EPG data.

5. The method of claim 4, further comprising:
determining whether at least one similar keyword to the at least one keyword is found in searching the EPG data; and
displaying the at least one similar keyword, if the at least one similar keyword is found in searching the EPG data.

6. The method of claim 1, further comprising, if the broadcast information related to the at least one keyword is a broadcast program title, determining whether the broadcast program is currently airing.

7. The method of claim 6, wherein, if the broadcast program is currently airing, generating the broadcast control signal comprises generating a control signal to change a current broadcast channel to a broadcast channel that is providing the broadcast program.

8. The method of claim 6, further comprising displaying a message indicating that the broadcast program is not currently airing, if the broadcast program is not currently airing.

9. The method of claim 8, further comprising one of:
displaying a date and time at which the broadcast program previously aired; and
displaying a date and time at which the broadcast program is scheduled to air.

10. The method of claim 6, further comprising generating a control signal to play back a previously-stored version of the broadcast program, if the broadcast program is not currently airing.

11. A mobile device that communicates with an external device, the mobile device comprising:
an input unit that receives a user voice command;
a keyword extracting unit that extracts at least one keyword from the user voice command;
a search unit that searches Electronic Program Guide (EPG) data for broadcast information related to the at least one keyword; and
a generating unit that generates a broadcast control signal corresponding to the broadcast information related to the at least one keyword.

12. The mobile device of claim 11, further comprising a communicating unit that transmits the broadcast control signal to the external device.

13. The mobile device of claim 11, further comprising a control unit that changes a broadcast program channel of the mobile device using the broadcast control signal.

14. The mobile device of claim 11, further comprising a display unit that displays a message indicating that there are no broadcasts provided by the external device or the mobile device corresponding to the user voice command, when no broadcast information related to the at least one keyword is found in searching the EPG data.

15. The mobile device of claim 14, further comprising a determining unit that determines whether at least one similar keyword to the at least one keyword is found in searching the EPG data,
wherein the display unit displays the at least one similar keyword, if the at least one similar keyword is found in searching the EPG data.

16. The mobile device of claim 11, further comprising a determining unit that determines whether a broadcast program is currently airing, if the broadcast information is a title of the broadcast program.

17. The mobile device of claim 16, wherein, if it is determined that the broadcast program is currently airing, the generating unit generates a control signal to change a current broadcast channel to a broadcast channel that is providing the broadcast program.

18. The mobile device of claim 16, further comprising a display unit that displays a message indicating that the broadcast program is not currently airing, if it is determined that the broadcast program is not currently airing.

19. The mobile device of claim 18, wherein the display unit displays a date and time at which the broadcast program previously aired or is scheduled to air.

20. The mobile device of claim 16, wherein the generating unit generates a control signal to play back a previously-stored version of the broadcast program, if the broadcast program is not currently airing.
